(19) United States
(12) Patent Application Publication
(10) Pub. No.: US 2006/0005483 A1
(43) Pub. Date: Jan. 12, 2006

(54) Edge cauterized layered films, methods of manufacture, and uses thereof

(76) Inventors: Steven Allen Barth, Martinsville, VA (US); Lisa Yvonne Winckler, Collinsville, VA (US)

Correspondence Address: BRENC LAW, 47 BANKS ROAD, SIMSBURY, CT, 06070, US

(21) Appl. No.: 10/885,061

(22) Filed: Jul. 7, 2004

(51) Int. Cl. E06B 3/00

(52) U.S. Cl. 52/204.5

(57) ABSTRACT

The present invention is in the field of thermoplastic films used to improve performance of windows, glazings, and other devices, and, more specifically, the present invention is in the field of films that are edge cauterized, methods of edge cauterizing such films, and windows, polymeric interlayers, glazings, and other devices comprising such films.

### FIELD OF THE INVENTION

The present invention is in the field of thermoplastic films used to improve performance of windows, glazings, and other devices, and, more specifically, the present invention is in the field of films that are edge cauterized, methods of edge cauterizing such films, and windows, polymeric interlayers, glazings, and other devices comprising such films.

### BACKGROUND

Polymeric, transparent window films that can be disposed directly on the surface of window panes, either before or after installation of the pane in a frame, have been used to reduce the amount of electromagnetic radiation of various wavelengths passing through the panes from the outside. Window films have also been used to maintain heat in an interior space by reducing heat radiation loss through a window. Conventional window films can thus be used to reduce loads on the heating, ventilating, and air conditioning (HVAC) systems. Lower HVAC loads result in lower costs for heating and/or cooling an interior building space.

Window films, which are also known as solar control films, can have a variety of film structures. For example, one common type of solar film is a laminate structure having a base layer, such as a poly(ethylene terephthalate) sheet, upon which a relatively thin, transparent, solar reflective, metallized layer has been deposited. A protective layer, such as a second layer of poly(ethylene terephthalate), may then be applied over the solar reflective layer to form a multiple layer window film (see, for example, U.S. Pat. No. 4,634,637).

Solar control films are typically bonded to a surface of a glass window using a suitable transparent adhesive (see, for example U.S. Pat. Nos. 4,429,005 and 4,408,021). In general, when applied to an installed window, a window film is cut to substantially cover the entire window glass area.

It is sometimes desirable to seal the edges of the window film with a suitable sealant in order to protect any metallized deposits or layers of the solar film from the corrosive effects of window cleaners and environmental conditions such as moisture and salt. Such sealing can reduce oxidation or corrosion of, for example, any metallized layers.

Conventional edge sealants, which can be polymer based, can be applied in a number of ways. For example, edge sealants have been applied directly from a nozzle or spout of a container onto the edge of a window film. Such applications, however, often require the use of solvent based sealants, which can be undesirable for some applications.

In addition to windows, many other applications include the use of thermoplastic films that are susceptible to corrosion and for which improved edge sealing would be desirable, for example, displays and filters.

There is therefore a need in the art for edge sealed window films that can be sealed either before or after installation of a window in a structure, and that are sealed easily and effectively.

### SUMMARY OF THE INVENTION

Now, according to the present invention, edge cauterized window films, films used in other applications, and methods for producing such films are provided. The films of the present invention, in some embodiments, include two layers of thermoplastic, for example polyester, film between which is disposed one or more performance layers. Performance layers typically can include, for example, metallized layers that are subject to corrosion or other degradation if, for example, water penetrates into the performance layers. Through the edge sealing methods taught herein, which include edge cauterization methods that can be performed before or after fabrication and/or installation of a window unit or device, penetration of water into the performance layers can be reduced or eliminated, thereby extending the useful life of the film.

The present invention includes a method for sealing a layered film having a performance layer and at least one polymer layer, comprising: installing said film on a rigid substrate, and, edge cauterizing said film.

The present invention includes a multiple layer panel, comprising: a rigid substrate; and, an edge cauterized layered film having a performance layer and at least one polymer layer disposed on said rigid substrate.

### BRIEF DESCRIPTION OF THE FIGURES

FIG. 1 is a schematic representation of a cross section of one embodiment of a window film that is used with the present invention.

FIG. 2 is a schematic representation of a cross section of one embodiment of a window film bonded in position to a window that is disposed in a window frame.

FIG. 3 is a schematic representation of a cross section of one embodiment of a window film of the present invention showing the result of edge cauterization of a window film.

FIG. 4 is a schematic representation of a cross section of one embodiment of a window film of the present invention showing the result of edge cauterization of a window film.

FIG. 5 is a schematic representation of a cross section of one embodiment of a window film of the present invention showing the result of edge cauterization of a window film.

### DETAILED DESCRIPTION

The present invention, in some embodiments, includes the use of a heat source to edge seal a layered film. In various embodiments, the layered film can be a window film that can be edge sealed during window production before or after application of the window film to the window glass. In various other embodiments, the window films of the present invention can be applied to a window that has already been installed, which is known as retrofitting the window film onto the window. In retrofit applications, the window films of the present invention can be edge cauterized before or after application of the window film to a window. In further embodiments, edge sealed window films of the present invention are incorporated into a polymer interlayer that can be used in automotive and architectural applications. Window films of the present invention can be used with many types of windows, including automotive and single and multiple pane architectural windows.

Layered films of the present invention can be non-window films as well as window films. Generally both types of films can comprise the same materials and can be formed and processed in the same manner, as described herein, with the particular physical and optical properties chosen to suit the application. As used herein, a “layered film” is a multiple layer construct having at least one thermoplastic layer and at least one performance layer, which can be, for example, a metallized layer. Of course, as described elsewhere herein, layered films of the present invention can comprise more than two layers, including further thermoplastic layers, performance layers, and hardcoats. As will be described, the layered films of the present invention can be edge cauterized prior to application or after application of the films to a rigid substrate. The rigid substrate can be any transparent substrate that is conventionally used for window glazings and for display panels and optical filters, for example, but not limited to, glass and polymers, such as acrylics, as disclosed elsewhere herein. The combination of a rigid substrate and a layered film, as used herein, is a “multiple layer panel.”

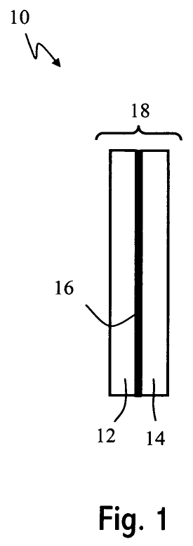

The following description of the figures exemplifies the use of window film type layered films. As shown in FIG. 1 generally at 10, a first thermoplastic film 12 and a second thermoplastic film 14 are arranged so that a performance layer 16 is disposed between the two thermoplastic layers 12, 14. This window film 18 arrangement can be achieved by applying the performance layer 16 to either thermoplastic film layer and then bonding the other thermoplastic film layer to the exposed surface of the performance layer. Any conventional methods can be employed to arrive at the window film 18 shown in FIG. 1 (see, for example U.S. Pat. Nos. 4,429,005 and 4,408,021 for a description of techniques for bonding polyester film layers to glass).

In conventional applications, the window film shown in FIG. 1 is either bonded on a pane of glass which is then installed in a window frame, or the window film is bonded to the exposed pane of glass on a window that has already been installed in, for example, a building. In any of these cases, water, cleaners, salt, and other corrosive materials can infiltrate the performance layer 16 and cause degradation of the window film 18.

Now, according to the present invention, it has been discovered that, surprisingly, edge cauterization of a window film can effectively seal the edges of the window film, thereby sealing the performance layer 16 within the first thermoplastic layer 12 and the second thermoplastic layer 14.

As used herein, “edge cauterization” means the use of a heated tool to simultaneously cut and heat a narrow region of a layered film, for example a window film, close to or exactly at the finished edge of the layered film in order to both cut and seal the layered film.

For each embodiment of the present invention in which edge cauterization is used, there is a corresponding additional embodiment of the present invention in which a similar result as the result in edge cauterization is produced by sequentially cutting the layered film near or at the finished edge of the layered film, and then applying heat to the cut edge.

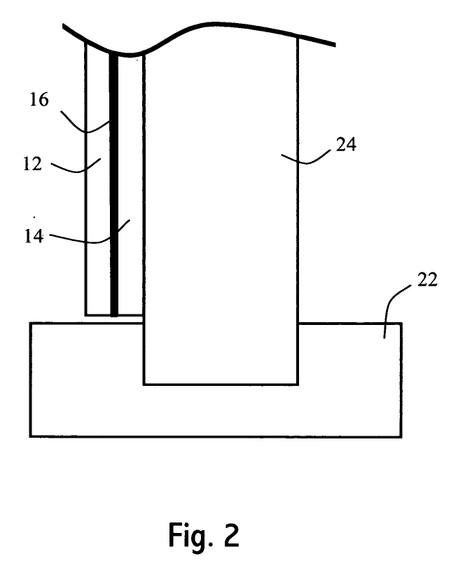

FIG. 2 shows the window film 18 of FIG. 1 disposed against a pane of glass 24 that is seated in a frame 22. As shown in this schematic, for a retrofit application, the window film is typically bonded to the glass 24 with an adhesive (not shown) and then trimmed close to the frame 22 to produce a finished appearance.

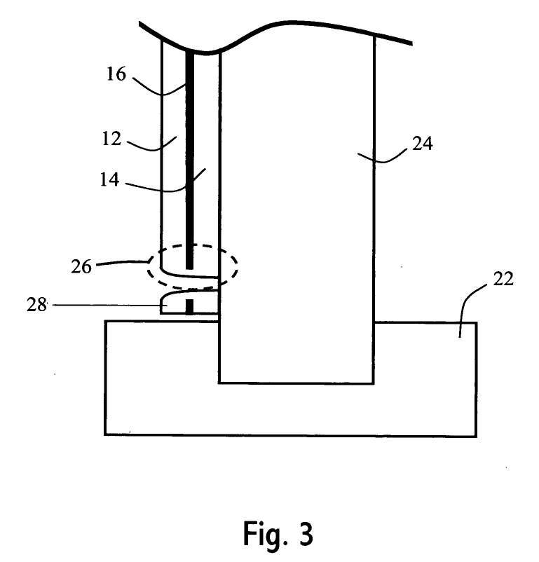

According to the present invention and as shown in FIG. 3, a retrofitted window film can be edge cauterized to produce the finished window film having a sealed edge 26. As shown in this Figure, the first and second thermoplastic layers 12, 14 have been melted and conjoined through the edge cauterization process to produce a sealed edge 26 that functions to resist the penetration of corrosive substances into the performance layer 16. FIG. 3 shows a window film that has been fitted to the glass 24 and trimmed close to the window frame 22 prior to the cauterization step, which, in some embodiments, can result in a small strip 28 of the window film along the edge of the glass 24 next to the frame 22. Of course the finished edge shown in FIG. 3 can also be produced by edge cauterizing a window film that has been bonded to a window prior to installation of the window in a building.

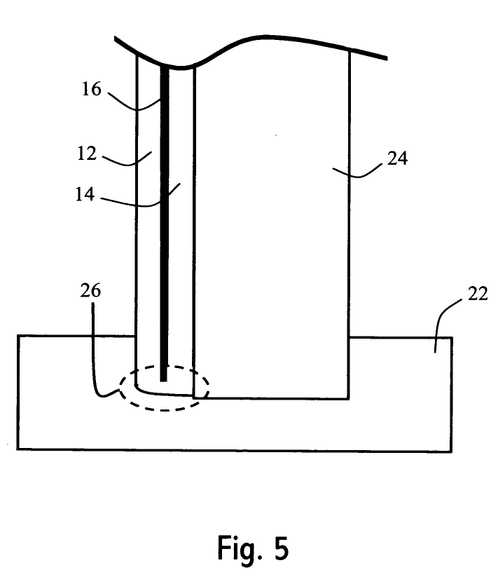

In other embodiments, window films that have been bonded to glass prior to insertion of the glass in a frame, which results in the window film extending into the window frame 22 (as shown in FIG. 5), can be edge cauterized according to the present invention as described above for FIG. 3. The resulting film and window will have a sealed edge 26, as shown in FIG. 3, but will differ from the window film shown in FIG. 3 in that the small strip 28 will extend into the frame 22 in these embodiments.

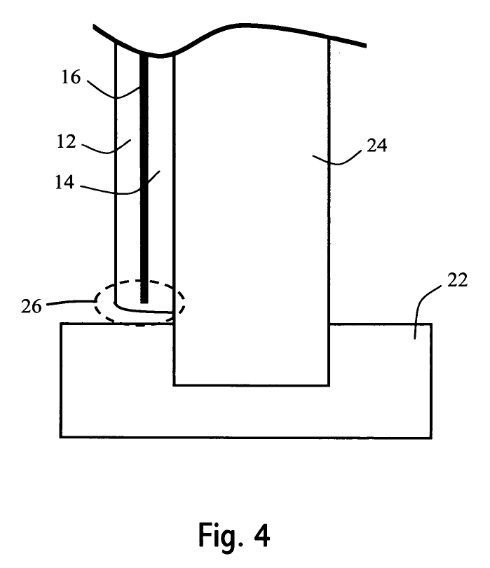

FIG. 4 represents further embodiments of the present invention. In these embodiments, the sealed edge 26 produced by edge cauterization is close to or touching the window frame 22. This result can be achieved, for example, by either edge cauterizing the window film exactly to or near to the dimensions of the exposed glass 24 prior to installation of the window film on the glass 24, or by installing an oversized window film on the glass, edge cauterizing the window film along the window frame 22, and removing the extra window film material. An example of the first type of installation would be cutting a 120 cm square window film to a 100 cm square, edge cauterized window film using a cauterizing tool to cut out the 100 cm square from the original 120 cm square, and then bonding the 100 cm square, edge cauterized window film to a window pane that measures 100 cm×100 cm of exposed glass surface inside of the window frame. An example of the second type of installation would be bonding a 120 cm square window film directly onto the exposed surface of a 100 cm×100 cm window pane, edge cauterizing the window film next to the window frame, and then removing the excess window film from around the edge of the window pane.

FIG. 5 represents further embodiments of the present invention in which a window film has been edge cauterized to form a sealed edge 26 prior to assembly of the glass pane 24 into the window frame 22. In these embodiments, the sealed edge 26 can be formed by, for example, edge cauterizing a window film to the size of the glass pane and then bonding the film to the glass or by bonding an oversized window film to a pane of glass and then edge cauterizing the window film to the size of the pane of glass or closely thereto.

The edge cauterization disclosed herein can be performed with any tool or combination of tools that is capable of achieving the temperature needed to melt and/or fuse one or all of the thermoplastic layers of the layered films while also allowing a user to produce a cauterized edge on the desired edge of the work piece. Devices that can be used include any soldering iron type apparatuses, heated blades and tools with heated edges, and pinpoint flame devices with blade or edge attachments that are capable of providing a very fine, even flame to heat the blade or edge or the layered film. As will be recognized by those of skill in the art, many variations of device can be adapted for use in the cauterization step of the present invention. In one embodiment, edge cauterization is accomplished by using a soldering iron with an appropriately sized iron, which will generally be a fine point or fine flat blade. This embodiment is particularly useful for retrofit or in-field type applications for which larger devices may be undesirably cumbersome. In another embodiment, large heated blades can be used to edge cauterize entire layered films or whole sides of layered films, for example in window film applications. This embodiment is particularly useful for creating window film of a predetermined size for later application.

As described above, and herein elsewhere, the present invention includes methods of sealing a layered film, comprising edge cauterizing any of the layered films described herein.

The present invention includes methods of sealing a layered film, comprising forming a layered film and edge cauterizing the layered film, wherein the layered film comprises two layers of thermoplastic polymer between which is disposed a performance layer.

The present invention also includes methods of sealing a window film, comprising the steps of installing any window film described herein on a window pane, and edge cauterizing the window film. The window pane can be disposed in a window frame, or not, and the window frame can be disposed in an installed or uninstalled window. The methods disclosed herein for edge cauterizing window films on installed windows are applicable both to films that are applied immediately prior to edge cauterization, and to films that have been installed on windows for extended periods prior to edge cauterization.

The present invention further includes windows comprising any edge sealed window film described herein, as well as any devices, including displays and optical filters comprising any edge sealed window film described herein.

The present invention also includes laminated glass panel interlayers incorporating any of the edge cauterized window films of the present invention. As is known in the art, polyester-type film layers can be disposed between two layers of a thermoplastic polymer such as poly(vinyl butyral) to form a multiple layer “interlayer” for use in laminated safety glass. The interlayer is typically disposed between two panes of glass to form, for example, automotive windshields and architectural safety glass. The present invention also includes laminated glass embodiments in which a window film of the present invention is disposed next to a single layer of a poly(vinyl butyral). In this embodiment, a layer of thermoplastic film such as poly(ethylene terephthalate) with a metallized surface can be bonded to glass with the metallized surface facing away from the glass. A layer of poly(vinyl butyral) or similar impact resistant polymer is disposed in contact with the metallized surface of the thermoplastic film. Other variations using poly(vinyl butyral) or a similar thermoplastic are included within the scope of the present invention, including embodiments using multiple layers of poly(vinyl butyral) and/or poly(ethylene terephthalate) in a single window film.

As mentioned above, for each of the above embodiments disclosed above and elsewhere herein throughout in which an edge cauterized polymer film is described, a corresponding embodiment exists in which a sealed edge is accomplished by first cutting and then heating the edge of the polymer film.

The present invention also includes embodiments having layered films that utilize a hardcoat comprising a thermoplastic polymer performance film with a metallized surface or a similar surface that is covered with a coating of thermoplastic, thermoset, or cross linked material that functions as a protective layer, such as a acrylate and urethane hardcoats.

Examples of useful hardcoats include cured products resulting from heat or plasma treatment of (a) a hydrolysis and condensation product of methyltriethoxysilane; or (b) mixtures of poly(silicic acid) and copolymers of fluorinated monomers with compounds containing primary and secondary alcohol groups. Hardcoats that are useful also include acrylate functional groups, such as a polyester, polyether, acrylic, epoxy, urethane, alkyd, spiroacetal, polybutadiene or polythiol polyene resin having a relatively low molecular weight; a (meth)acrylate oligomer or prepolymer of a polyfunctional compound such as a polyhydric alcohol; or a resin containing, as a reactive diluent, a relatively large amount of a monofunctional monomer such as ethyl (meth)acrylate, ethylhexyl (meth)acrylate, styrene, methylstyrene or N-vinylpyrrolidone, or a polyfunctional monomer such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di(meth)acrylate. Other hardcoats, as are known in the art, can be used.

This thermoplastic layer/metal layer/hardcoat construct is, as defined herein, a layered film that can be used in any of the layered film edge cauterized embodiments of the present invention.

Further embodiments involve using a conventional edge sealant to further seal any edge cauterized layered films. In these embodiments, any conventional sealant can be used, where appropriate to the application (see, for example, U.S. Pat. Nos. 6,090,451 and 6,294,233).

In other embodiments of the present invention, two thermoplastic layers having no performance layer disposed therebetween are edge cauterized using any of the techniques disclosed herein. In these embodiments, edge sealing similarly prevent ingress of water and other contaminants between the layers.

In further embodiments of the present invention, the edge cauterization methods disclosed herein can be used to edge cauterize non-window applications in which a layered film is used, such as displays and optical filters. Examples include display screens and panels, such as cathode ray tube, flat panel liquid crystal displays, plasma display panels, lighting applications such as theatrical and architectural, telecommunications devices, for example, hand held devices such as cellular phones, and other applications in which a corrosion sensitive laminate having a thermoplastic layer is used. These embodiments can comprise two layers of thermoplastic polymer with or without a performance layer disposed therebetween, as well as the polymer/metal/hardcoat embodiments described above.

Various embodiments employ solid, transparent substrates in place of glass, such as acrylics, Plexiglass®, and Lexan® type surfaces. In these embodiments, one or more thermoplastic layers can be applied to the solid, transparent substrate and can then be edge cauterized. In some embodiments, under the appropriate conditions, edge cauterization will result in the conjoining of the one or more thermoplastic layers with the substrate.

Thermoplastic Film

The first thermoplastic film 12 and the second thermoplastic film 14 shown in the Figures and described herein, as well as the thermoplastic layer in the hardcoat embodiments and non-window layered films, can be the same or different, and can be any suitable thermoplastic film that is used in window manufacture. In various embodiments, the thermoplastic film can comprise polycarbonates, acrylics, nylons, polyesters, polyurethanes, polyolefins such as polypropylene, cellulose acetates and triacetates, vinyl acetals, such as poly(vinyl butyral), vinyl chloride polymers and copolymers and the like, or another plastic suitable for use in a performance film.

In various embodiments, the thermoplastic film is a polyester film, for example poly(ethylene terephthalate). In various embodiments the thermoplastic film can have a thickness of 0.012 mm to 0.40 mm, preferably 0.025 mm to 0.1 mm, or 0.04 to 0.06 mm. The thermoplastic film can be surface treated or coated with a performance layer 16, which can be a metallized layer, to improve one or more properties, such as infrared radiation reflection or to provide for conductivity. These performance layers can include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known, (see, for example, U.S. Pat. Nos. 4,017,661 and 4,786,783), the metal layer(s) may optionally be electrically resistance heated for defrosting or defogging of any associated glass layers. The performance layer can include, where appropriate, a primer layer to facilitate bonding of metallized layers to the polymeric substrate. The performance layer can also be a metallic grid, for example, copper, or other metallic screen for preventing the transmission of certain wavelengths of radiation through the film. Further, the performance layer can also comprise any suitable metal in the metallized layer, as is known in the art, for example, silver, copper, aluminum, alloys of the foregoing, and the like, and can be applied using known sputtering and vapor deposition techniques, for example.

The thermoplastic films, in some embodiments, are optically transparent (i.e. objects adjacent one side of the layer can be comfortably seen by the eye of a particular observer looking through the layer from the other side). In various embodiments, the thermoplastic film comprises materials such as re-stretched thermoplastic films having the noted properties, which include polyesters. In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 min. at 150 degrees C.).

Various coating and surface treatment techniques for poly(ethylene terephthalate) film that can be used with the present invention are disclosed in published European Application No. 0157030.

By virtue of the present invention, layered films are provided that are resistant to the incursion of corrosive substances, which allows for longer film life and simpler installation.

Although embodiments of the present invention have been described in various embodiments, it will be clear to those of ordinary skill in the art that many other permutations are possible and are within the scope and spirit of the present invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeable with any ranges, values, or characteristics given for any of the other components of the invention, where compatible, to form an embodiment having defined values for each of the components, as given herein throughout. For example, a polymer sheet can be formed comprising sodium acetate in any of the ranges given in addition to any of the ranges given for plasticizer, to form many permutations that are within the scope of the present invention.

Any figure reference numbers given within the abstract or any claims are for illustrative purposes only and should not be construed to limit the claimed invention to any one particular embodiment shown in any figure.

Unless otherwise noted, drawings are not drawn to scale.

Each reference, including journal articles, patents, applications, and books, referred to herein is hereby incorporated by reference in its entirety.

We claim:

1. A method for sealing a layered film having a performance layer and at least one polymer layer, comprising:
installing said film on a rigid substrate, and,
edge cauterizing said film.

2. The method of claim 1, wherein said rigid substrate is a window glazing.

3. The method of claim 2, wherein said window glazing is a pane of glass.

4. The method of claim 3, wherein said window glazing comprises a polymer.

5. The method of claim 2, wherein said window glazing is disposed in a frame.

6. The method of claim 5, wherein said frame is disposed in an uninstalled window.

7. The method of claim 1, wherein said installing comprises bonding said film to said rigid substrate.

8. The method of claim 1, wherein said film comprises two layers of polyester between which is disposed said performance layer.

9. The method of claim 8, wherein said polyester is poly(ethylene terephthalate).

10. The method of claim 1, wherein said edge cauterizing is done with a soldering iron.

11. The method of claim 1, wherein said film comprises a layer of polyester and a hardcoat layer between which is disposed said performance layer.

12. The method of claim 1, wherein rigid substrate is a polymeric layer for a device display or optical filter.

13. The method of claim 12, wherein said polymeric layer is for a device display.

14. The method of claim 12, wherein said polymer layer is for an optical filter.

15. A multiple layer panel, comprising:
a rigid substrate; and,
an edge cauterized layered film having a performance layer and at least one polymer layer disposed on said rigid substrate.

16. The panel of claim 15, wherein said rigid substrate is a window glazing.

17. The panel of claim 16, wherein said window glazing is a pane of glass.

18. The panel of claim 17, wherein said window glazing comprises a polymer.

19. The panel of claim 16, wherein said window glazing is disposed in a frame.

20. The panel of claim 19, wherein said frame is disposed in an uninstalled window.

21. The panel of claim 15, wherein said film comprises two layers of polyester between which is disposed said performance layer.

22. The panel of claim 21, wherein said polyester is poly(ethylene terephthalate).

23. The panel of claim 15, wherein said film comprises a layer of polyester and a hardcoat layer between which is disposed said performance layer.

24. The panel of claim 15, wherein rigid substrate is a polymeric layer for a device display or optical filter.

25. The panel of claim 24 wherein said polymeric layer is for a device display.

26. The panel of claim 24, wherein said polymer layer is for an optical filter.
